(19) United States
(12) Patent Application Publication
(10) Pub. No.: US 2012/0263552 A1
(43) Pub. Date: Oct. 18, 2012

(54) VEHICLE CARGO RETENTION SYSTEM

(75) Inventor: Joel S. Hooton, Chesterfield, MI (US)

(73) Assignee: GM GLOBAL TECHNOLOGY OPERATIONS LLC, Detroit, MI (US)

(21) Appl. No.: 13/085,766

(22) Filed: Apr. 13, 2011

(51) Int. Cl. B65D 63/00; B62D 33/04; B60P 7/06

(52) U.S. Cl. 410/96; 296/182.1

(57) ABSTRACT

A vehicle body includes structure that defines a first surface, a second surface, a third surface, and an opening between the first and third surfaces. The first surface and the second surface at least partially define lateral boundaries of a vehicle cargo area. The third surface at least partially defines a compartment separate from the cargo area. A first fastening element is mounted with respect to a flexible member. A second fastening element is mounted with respect to the second wall and is releasably engageable with the first fastening element. The flexible member is selectively movable through the opening from a stowed configuration to a deployed configuration. In the stowed configuration, the flexible member is substantially entirely outside the cargo area. In the deployed configuration, the flexible member extends sufficiently across the cargo area such that the first fastening element is engaged with the second fastening element.

### TECHNICAL FIELD

This invention relates to systems for securing cargo in a vehicle.

### BACKGROUND

Vehicles often include a load floor configured to support cargo in a cargo area. For example, minivans and sport-utility vehicles typically include a cargo area in the rear of the vehicle. Access to the cargo area is provided by a rear body opening that is selectively closed by a rear closure panel, such as a tailgate or a liftgate. Similarly, pickup trucks include a cargo area, i.e., a cargo box, with access to the cargo box being provided by an opening at the rear of the truck and that is selectively closed by a tailgate.

### SUMMARY

A vehicle having a system for securing cargo is provided. The vehicle includes a vehicle body having structure that defines a first surface, a second surface, a third surface, and an opening between the first and third surfaces. The first surface and the second surface at least partially define lateral boundaries of a vehicle cargo area. The third surface at least partially defines a compartment separate from the cargo area. A flexible member is at least partially disposed within the compartment. A first fastening element is mounted with respect to the flexible member. A second fastening element is mounted with respect to the second wall and is releasably engageable with the first fastening element.

The flexible member is selectively movable through the opening from a stowed configuration to a deployed configuration. In the stowed configuration, the flexible member is substantially entirely outside the cargo area and disposed primarily within the compartment. In the deployed configuration, the flexible member extends sufficiently across the cargo area such that the first fastening element is engaged with the second fastening element.

In the deployed configuration, the flexible member may be used to interact with cargo in the cargo area to limit movement of the cargo relative to the vehicle body during vehicle operation. The flexible member is conformable to various sizes and shapes of cargo, and thus may be more adaptable to cargo of varying sizes than cargo nets and cargo bins. In the stowed configuration, the flexible member does not take up any significant space within the cargo area. Furthermore, since the flexible member is integrated into the vehicle body in the stowed configuration, the flexible member will not be lost or misplaced by a vehicle user; the flexible member will remain with the vehicle body until used again by a vehicle user.

A method of securing cargo inside a vehicle is also provided. The method includes providing a vehicle body having a flexible member and structure defining a first surface, a second surface, a third surface, and an opening between the first and third surfaces. The first surface and the second surface at least partially define lateral boundaries of a vehicle cargo area. The third surface at least partially defines a compartment in which at least a portion of the flexible member is disposed.

The method also includes placing inanimate cargo within the cargo area, extending the flexible member across the cargo area, and placing the flexible member in contact with the inanimate cargo. The method further includes operatively connecting the flexible member to the second surface.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, rear view of a vehicle body defining a cargo area and having a cargo retention system in a stowed configuration;

FIG. 2 is a schematic, perspective view of part of the cargo retention system;

FIG. 3 is a schematic, perspective view of another part of the cargo retention system; and

FIG. 4 is a schematic, rear view of the vehicle body of FIG. 1 with the cargo retention system in a deployed configuration.

### DETAILED DESCRIPTION

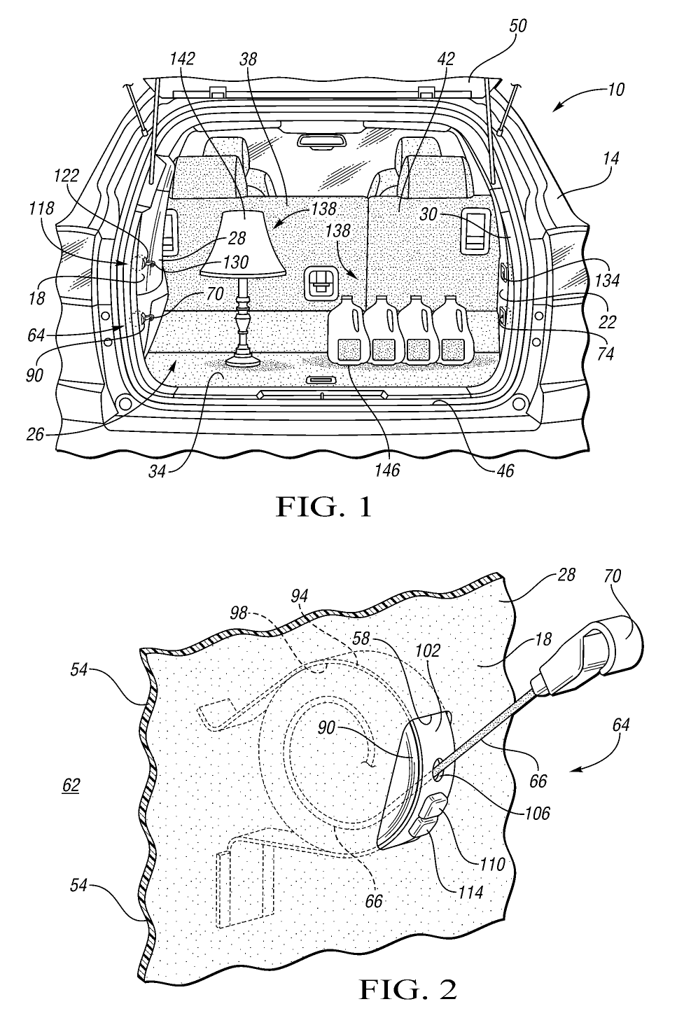

Referring to FIG. 1, a vehicle 10 includes a vehicle body 14. The vehicle body 14 includes structure defining a first surface 18 and a second surface 22. The first surface 18 and the second surface 22 are generally vertically oriented (i.e., are more vertical than horizontal), and at least partially define the lateral boundaries of a vehicle cargo area 26. More specifically, the structure includes a first side panel 28, which has the first surface 18, and a second side panel 30, which has the second surface 22.

The vehicle body 14 also includes a load floor 34, which defines the lower extent of the cargo area 26. In the embodiment depicted, the rear-facing surfaces of passenger seats 38, 42 define the forwardmost extent of the cargo area 26. The vehicle body 14 defines an opening 46 at the rear end of the vehicle body 14 through which the cargo area 26 is accessible from outside the vehicle body 14.

An enclosure, such as a liftgate 50, is selectively movable between an open position, as shown in FIG. 1, and a closed position. In the open position, the liftgate 50 does not obstruct the opening 46, and thus the cargo area 26 is accessible from outside the vehicle body 14. In the closed position, the liftgate 50 obstructs the opening 46, and thus acts as a barrier between the outside of the vehicle body 14 and the cargo area 26, as understood by those skilled in the art. In the embodiment depicted, there are no vehicle seats inside the body 14 rearward of the cargo area 26. Windows (not shown in FIG. 1) cooperate with the first and second surfaces 18, 22 to further define the lateral boundaries of the cargo area 26.

Referring to FIG. 2, wherein like reference numbers refer to like components from FIG. 1, the structure of the vehicle body 14 also defines a third surface 54. In the embodiment depicted, the third surface 54 is defined by the first side panel 28. The third surface 54 is on the opposite side of the panel 28 from the first surface 18. The first side panel 28 also defines an opening 58 between the first and third surfaces 18, 54. The third surface 54 at least partially defines a compartment 62.

The vehicle 10 includes a cargo retention system 64. The cargo retention system 64 includes a flexible member 66, such as a strap, cord, cable, etc., that is at least partially disposed within the compartment 62. A first fastening element 70 is mounted to the end of the flexible member 66. In the embodiment depicted, the first fastening element 70 is a hook that is mounted to the end of the flexible member 66.

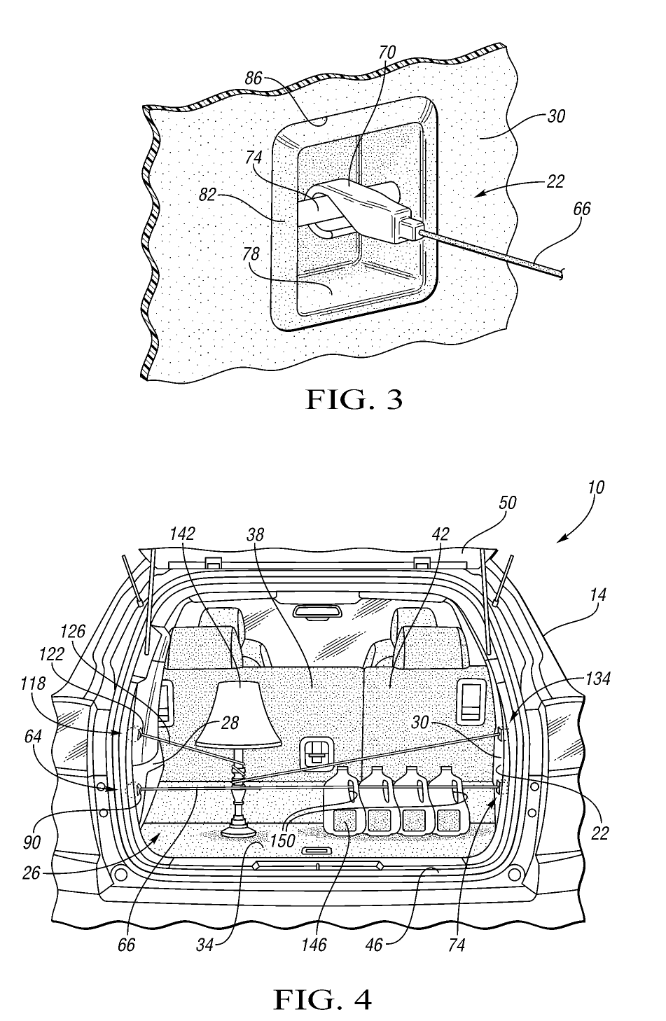

Referring to FIG. 3, a second fastening element 74 is mounted with respect to the second surface 22. The second fastening element 74 is releasably engageable with the first fastening element 70 to operatively connect the flexible member 66 to the second surface 22. In the embodiment depicted, the second fastening element 74 is a cylindrical shaft with which the hook 70 is engageable, as shown in FIG. 3. Further, in the embodiment depicted, the cylindrical shaft is disposed within a concavity 78 defined by a member 82. The member 82 extends through a hole 86 formed in the second surface 22.

In an alternative embodiment (not shown), the second fastening element includes a U-shaped member to which the hook of fastening element 70 is selectively engageable. The U-shaped member may be rotatably mounted with respect to the second surface 22 such that the U-shaped member is selectively rotatable from a stowed position to an extended position. In the stowed position, the U-shaped member is generally parallel to the second surface 22, and in the extended position, the U-shaped member is generally perpendicular to the second surface 22.

Other fastening element types may be employed for the first and second fastening elements within the scope of the claimed invention. For example, fastening elements may include latches, clips, hook and loop fasteners, etc. within the scope of the claimed invention.

The flexible member 66 is selectively movable through the opening 58 from a stowed configuration, as shown in FIG. 1, to an extended or deployed configuration, as shown in FIG. 4. In the stowed configuration, the flexible member 66 is substantially entirely outside the cargo area 26, i.e., most or all of the flexible member 66 is inside the compartment 62 and/or the opening 58. It may be desirable for a small amount of the flexible member 66 to be disposed within the cargo area 26 in the stowed configuration, e.g., to facilitate access to the flexible member 66 by a user of the vehicle 10. Accordingly, a small amount, such as one or two inches, of the flexible member 66 may extend into the cargo area in the stowed configuration within the scope of the claimed invention.

Referring to FIG. 4, in the extended configuration, more of the flexible member 66 is disposed within the cargo area 26 than in the stowed configuration. More specifically, in the extended configuration, the flexible member 66 extends sufficiently across the cargo area 26 such that the first fastening element 70 is engaged with the second fastening element 74, as shown in FIGS. 3 and 4.

Referring again to FIG. 2, a retractor 90 is operatively connected to the first side panel 28. In the embodiment depicted, the retractor includes a housing 94. The housing 94 defines a compartment 98. Most of the housing 94 is disposed within the compartment 62 at least partially formed by the third surface 54, and thus the compartment 98 is at least partially coextensive with the compartment 62. A portion 102 of the housing 94 extends through opening 58. The portion 102 defines an opening 106 through which the flexible member 66 extends.

The retractor 90 is configured to bias the flexible member 66 toward the stowed configuration. That is, the retractor 90 causes the retraction of the flexible member 66 into the compartment 98, and thus into compartment 62, in the absence of a countervailing force acting on the flexible member 66. It should be noted that, in the embodiment depicted, the surface of portion 102 may also be considered to partially define the lateral boundaries of the cargo area 26, and the inner surface of the housing 94 may be considered to define a compartment in which the flexible member 66 is at least partially stored in the stowed configuration.

The retractor 90 is selectively lockable to limit movement of the flexible member 66 relative to the retractor. In the embodiment depicted, the retractor 90 includes a first button 110 and a second button 114. The retractor 90 is configured such that depressing the first button 110 locks the flexible member 66, i.e., when the first button 110 is depressed, the retractor 90 prevents further movement of the flexible member 66 into the cargo area 26. Depressing the second button 114 unlocks the flexible member 66, i.e., when the flexible second button 114 is depressed, the flexible member may be retracted into the housing 94 or extended out from the housing 94.

When the flexible member 66 is in the extended configuration, the flexible member 66 may be used to restrain cargo inside the cargo compartment 26, thereby preventing the shifting, sliding, or tipping of the cargo during vehicle operation. Referring to FIGS. 1 and 4, the vehicle body 14 in the embodiment depicted includes another cargo retention system 118 that is substantially identical to cargo retention system 64. Cargo retention system 118 includes a refractor 122 mounted with respect to the first side panel 28 in a manner substantially identical to the retractor 90, a flexible member 126 with a hook 130 at one end, and a fastening element 134 mounted with respect to the second surface 22 and engageable with the hook 130. In the embodiment depicted, fastening element 134 is substantially identical to the fastening element 74.

A method of using a cargo retention system to retain cargo includes placing inanimate cargo 138 within the cargo area. In the embodiment depicted, inanimate cargo 138 includes a lamp 142 and milk jugs 146. The method also includes extending the flexible member 66, 126 into the cargo area 26, and placing the flexible member 66, 126 in contact with the inanimate cargo 138. In the embodiment depicted, extending the flexible members 66, 126 into the cargo area 26 requires overcoming the bias exerted by the retractors 90, 122.

In the embodiment depicted, flexible member 66 is placed in contact with the milk jugs 146 and flexible member 126 is placed in contact with the lamp 142, as shown in FIG. 4. Each jug 146 defines a respective aperture 150 between a handle and jug body. Placing the flexible member 66 in contact with the inanimate cargo 138, i.e., jugs 146, includes extending the flexible member 66 through the apertures 150 formed in the jugs 146. Placing the flexible member 126 in contact with the inanimate cargo 138, i.e., lamp 142, includes wrapping the flexible member 126 around the base of the lamp 142.

The method further includes operatively connecting the flexible member 66, 126 to the second surface 22. In the embodiment depicted, flexible member 66 is operatively connected to the second surface 22 by engaging the first fastening element 70 to the second fastening element 74, and flexible member 126 is operatively connected to the second surface 22 by engaging hook 130 to the fastening element 134.

The method further includes restricting movement of the flexible member 66, 126 from the compartment 62. In the embodiment depicted, this is accomplished by depressing button 110. Accordingly, one end of flexible member 66 is fixed with respect to surface 22 by the first and second fastening elements 70, 74, and the other end of flexible member 66 is fixed with respect to surface 18 by the locked retractor 90. Flexible member 126 is similarly secured. With the ends of the flexible members 66, 126 secured with respect to the surfaces 18, 22, the movement of the inanimate cargo 138 relative to the load floor 34 is restricted. In the embodiment depicted, the refractors 90, 122 eliminate any slack in the flexible members 66, 126 after fasteners 70, 130 are engaged with fasteners 74, 134.

To unload the cargo 138, button 114 is depressed to unlock the refractor 90, the first latching element 70 is disengaged from the second latching element 74, and the flexible member is refracted from the cargo area 26 into the compartment 54. Flexible member 126 is similarly disengaged and retracted.

It should be noted that the cargo area 26 depicted is enclosed by a roof, such as in a minivan or sport-utility vehicle. It should be noted, however, that other cargo area configurations may be employed within the scope of the claimed invention. For example, the cargo retention system 64 may be employed in the cargo area of a pickup truck within the scope of the claimed invention. It should also be noted that, in the embodiment depicted, fastening element 134 may be engageable with the first fastening element 70 to provide an alternative fastening location for flexible member 66.

While the best modes for carrying out the invention have been described in detail, those familiar with the art to which this invention relates will recognize various alternative designs and embodiments for practicing the invention within the scope of the appended claims.

1. A vehicle comprising:
a vehicle body having
a first side panel that at least partially defines the lateral boundaries of a vehicle cargo area on one side of the first panel and
a compartment on the other side of the first panel, the first panel defining an opening from the compartment to the vehicle cargo area;
a second side panel spaced apart from the first side panel and at least partially defining the lateral boundaries of the vehicle cargo area;
a flexible member being at least partially disposed within the compartment;
a first fastening element mounted with respect to the flexible member; and
a second fastening element mounted with respect to the second side panel and being releasably engageable with the first fastening element;
wherein the flexible member is selectively movable through the opening from a stowed configuration in which the flexible member is substantially entirely outside the cargo area to an extended configuration in which the flexible member extends sufficiently across the cargo area such that the first fastening element is engaged with the second fastening element.

2. The vehicle of claim 1, further comprising a retractor operatively connected to the body and configured to selectively bias the flexible member toward the stowed configuration;
wherein the retractor is at least partially disposed in the compartment.

3. The vehicle of claim 2, wherein the retractor is selectively lockable to prevent movement of the flexible member.

4. The vehicle of claim 1, further comprising a third latch element mounted with respect to the vehicle body and exposed to the cargo area;
wherein the third latch element is releasably engageable with the first latch element.

5. The vehicle of claim 1, further comprising a plurality of passenger seats disposed within the vehicle body; and
wherein the cargo area is rearward of all passenger seats within the vehicle body.

6. A method of securing cargo inside a vehicle comprising:
providing a vehicle body having a flexible member and structure defining a first surface, a second surface, a third surface, and an opening between the first and third surfaces, said first surface and said second surface at least partially defining lateral boundaries of a vehicle cargo area and said third surface at least partially defining a compartment that is outside the cargo area and in which at least a portion of the flexible member is disposed;
placing inanimate cargo within the cargo area;
extending the flexible member into the cargo area;
placing the flexible member in contact with the inanimate cargo; and
operatively connecting the flexible member to the second surface.

7. The method of claim 6, wherein operatively connecting the flexible member to the second surface includes engaging a first latching element with a second latching element;
wherein the first latching element is mounted with respect to the flexible member; and
wherein the second latching element is mounted with respect to the second surface.

8. The method of claim 7, wherein extending the flexible member into the cargo area includes overcoming a bias to move the flexible member.

9. The method of claim 7, further comprising disengaging the first latching element from the second latching element.

10. The method of claim 9, further comprising retracting the flexible member from the cargo area into the compartment.

11. The method of claim 6, wherein placing the flexible member in contact with the inanimate cargo includes extending the flexible member through an aperture in the inanimate cargo.

12. The method of claim 6, wherein placing the flexible member in contact with the inanimate cargo includes wrapping the flexible member around the inanimate cargo.

13. The method of claim 6, further comprising restricting movement of the flexible member from the compartment.
